(19) United States
(12) Patent Application Publication
(10) Pub. No.: US 2005/0121273 A1
(43) Pub. Date: Jun. 9, 2005

(54) Bypass valve for a hydraulic dashpot (shock absorber)

(76) Inventor: Wolfgang Hamers, Julich (DE)

Correspondence Address: Dr. Max Fogiel, 44 Maple Court, Highland Park, NJ, 08904, US

(21) Appl. No.: 10/998,876

(22) Filed: Nov. 29, 2004

(30) Foreign Application Priority Data
Dec. 5, 2003 (DE) 103 57 020.9-12

(51) Int. Cl. F16F 9/54

(52) U.S. Cl. 188/322.2

(57) ABSTRACT

Bypass valve for a hydraulic dashpot, or shock absorber. The valve connects the dashpot's two working compartments together hydraulically and is provided with a valve bolt (1). The valve bolt has a shaft (3) and a hollow adjustment bolt. The adjustment bolt slides back and forth in a stationary and at least partly hollow guide and operates in conjunction with at least one port (8) in the wall of the guide such that the open cross-section of the port can be varied by the axial motion of the adjustment bolt. A mechanism (A) for controlling the axial motion of the adjustment bolt. To minimize strains, the guide is fixed axially and radially and the adjustment bolt is larger than the guide, which accordingly constitutes a pin that the adjustment bolt can slide over axially.

The present invention concerns a bypass valve for a hydraulic dashpot, or shock absorber, that connects the dashpot's two working compartments together hydraulically and that is provided with a valve bolt, whereby the valve bolt has a shaft and a hollow adjustment bolt, and whereby the adjustment bolt slides back and forth in a stationary and at least partly hollow guide and operates in conjunction with at least one port in the wall of the guide such that the open cross-section of the port can be varied by the axial motion of the adjustment bolt, and with a mechanism for controlling the axial motion of the adjustment bolt.

Bypass valves of this genus are state of the art. In DE 4 011 358 C1 for example, a hollow piston rod constitutes a cylindrical guide, and the adjustment bolt travels back and forth inside it. The adjustment bolt is provided with a hollow cylindrical “valve cage” section that allows continuous variation of the open cross-section of bypass openings in the surface of the piston rod as the adjustment bolt travels back and forth therein. The level of shock absorption is accordingly constantly adjusted. The adjustment bolt in this embodiment is displaced by an electric motor inside the piston rod.

There is a drawback to the aforesaid state of the art in that the adjustment bolt is subjected to very powerful strain as the dashpot engages and disengages. These forces derive, especially while the dashpot is engaging and disengaging rapidly, from the rapid and accelerated rates, and from changes in the direction, of flow in the vicinity of the bypass openings. The more strain on the dashpot, that is, the wider the difference in pressure between the compartments separated by the piston and transferred to the adjustment bolt by the fluid. These forces considerably aggravate the exact displacement and security of the adjustment bolt and hence the precise adjustment of the fluid forces. In extreme cases it even becomes impossible.

Another consequence of the aforesaid strain is the severe friction that builds up between the cylindrical guide and the adjustment bolt. This friction must be overcome before the adjustment bolt can be moved. The motor that powers the move must accordingly be strong enough to resist even frictional resistance between the guide and the adjustment bolt. The motors employed with the system known from DE 4 011 358 C1 must accordingly have a relatively high output.

Another drawback is that such motors emit considerable heat when in operation, heat that absolutely must be eliminated from inside the piston rod. In practice this leads to overheating and to failure of the motor. The fluid in the vicinity of the piston rod is particularly exposed to heat while the dashpot is subject to high loads, and the heat generated by the motor cannot be adequately removed.

The object of the present invention is a bypass valve of the aforesaid genus improved to the extent that it will minimize the strain transmitted to the adjustment bolt. In particular, it will be possible to reliably and accurately displace the adjustment bolt even at maximal differences in pressure between the two compartments of the dashpot and to maintain it there.

This object is attained in accordance with the present invention in that the guide is fixed axially and radially and in that the adjustment bolt is larger than the guide, which accordingly constitutes a pin that the adjustment bolt can slide over axially.

The radially and axially fixed guide in the present invention accommodates most of the strain generated by the flowing fluid, and the adjustment bolt is, as a moving component, extensively uncoupled from the strain, ensuring reliable and precise establishment of an output parameter for the adjustment bolt at every phase of the dashpot's operation. Even at a maximal difference been the compartments, strain will accordingly have very little effect on the adjustment bolt, and it can reliably maintained in the ideal-output state.

Since the guide accommodates and diverts most of the strain, three will be no powerful friction between the adjustment bolt and the guide to be overcome before the adjustment bolt can be displaced. The mechanism that adjusts the adjustment bolt accordingly requires no high output, and a mechanism with a low starting power and lower loss can be employed, with low inherent heat and taking up less space. The mechanism can accordingly be simpler, less expensive, and more compact. The mechanism's lower inherent heat will prevent failure from overheating.

Locating bypass valves that connect the compression and suction compartments together at various sites in a dashpot is known from the pertinent state of the art. It is possible for example to integrate the valve bolt and its associated adjustment mechanism into the piston rod as in German 4 011 358 C1. It is also possible to accommodate the bypass valve in a separate modular housing secured to the wall of its tube and communicating with the compartments by way of bores through the tube, creating a “backpack” valve. The particular location of the bypass valve is not significant in the present invention, and the component is basically appropriate for all variations.

To facilitate manufacture, it is of advantage for the hollow adjustment bolt and the guide to be hollow, in the form of cylinders for example. It is also basically possible, however, to depart from the cylindrical, with one section of the circumference straight for fastening flat against the component.

The adjustment bolt will be more robust when it is hollow, if it is in one piece with the shaft of the valve bolt, creating an integrated component. If the hollow adjustment bolt is a separate component, in the form of a sleeve for example, as is basically possible, a reliable and long-lasting seam must be provided between the sleeve and the shaft. This joint, however, is unnecessary if the shaft and the hollow adjustment bolt are integrated.

Whereas the guide almost entirely intercepts and distributes the strains generated by the flowing fluid, no major friction will develop between the adjustment bolt and the guide even at maximal load on the dashpot. The adjustment mechanism need accordingly not overcome any major friction, even while the dashpot is subject to maximal load, in order to move axially into specific positions. The adjustment mechanism can accordingly just as well be a simple electromechanical linear drive, a solenoid for example. In this event the adjustment bolt will constitute a core that travels back and forth axially through an electrified coil, the strength of the current prescribing the desired position of he adjustment bolt.

To ensure that the bypass valve closes tight and accordingly to prevent it from constantly leaking, it will preferably include a seat. The guide in one preferred embodiment is provided with a radial shoulder that the free end of the hollow adjustment bolt operates in conjunction with on the valve-and-seat principle. In this event, the surface of the shoulder facing the free end of the adjustment bolt constitutes the seat, which the free end of the adjustment bolt can fit tightly into.

In this approach of course, the port in the wall of the guide must be above the shoulder to allow its open width to be varied by the axial motion of the adjustment bolt.

Fluctuations in pressure that occur during operation transmit strains to the face of the free end of the adjustment bolt. To keep these strains as weak as possible, the wall of the adjustment bolt should be as thin as possible in order to keep the face itself small. The size of the face can be reduced even further by introducing a slope into the free end of the hollow adjustment bolt. This approach will minimize the face at the free end of the adjustment bolt along with the number of strains transmitted by the fluctuations.

To even farther decrease the friction between the adjustment bolt and the guide, the surface of the guide includes at least one bleed groove. Several such grooves distributed axially along the surface will even further improve results. These grooves act like a hydrobearing. It is of advantage to introduce them above the port in the wall of the adjustment bolt facing the inner surface of the adjustment bolt.

One practical embodiment of the bypass valve in accordance with the present invention is provided with a spacer that shares an axis with the adjustment bolt and the guide, immediately surrounding the adjustment bolt and at some distance from the adjustment bolt. A cylindrical gap, which could also be called an outflow chamber, is accordingly left between the adjustment bolt and the spacer. The wall of the spacer is provided with ports, through which the gap communicates with the working space during the dashpot's tension stage. The cylindrical gap in the present invention allows the fluid to flow directed. The height and width of the chamber and the size and number of outflows can be selected to shape the flow such that part of it will immediately leave the chamber through the ports while the rest is diverted inside the chamber and aimed at the face of the adjustment bolt, where the component can be exploited to compensate for the strain.

Also practical is pressure compensation between the outflow chamber and the back, the side, that is, of the valve bolt facing away from the adjustment bolt. The present invention is accordingly provided with a vent in the shaft of the valve bolt between the space at the rear of valve bolt and the outflow chamber. Providing such pressure compensation bores is absolutely common in the field of the present invention. The resulting compensation decreases the number of strains acting on the valve bolt.

There are several embodiments of the present invention that differ in the dashpot's shock-absorbing properties while no current is traveling through the electrically operated adjustment mechanism, while, that is, no power is being applied to the circuit. In this event it is possible to distinguish between three valve states—1. no current, closed, 2. no current, open, and no current, partly open. State 1 produces a “hard” performance curve, State 2 a “soft” curve, and State 3 an intermediate curve. The electric adjustment mechanism in the bypass valve in accordance with the present invention operates in opposition to a recuperating force, which may be represented by a spring for example. While no current is traveling through the adjustment mechanism (as the result of a sudden power outage for example), the spring will maintain the mechanism in a specified position. Due to careful selection of the location of the at least one port in the wall of the guide, the adjustment bolt will keep the port either entirely (no current, closed) or partly covered (no current, partly open) or leave it uncovered (no current, open)

Not only the cylindrical guide in the present invention can be provided with one or more ports, but the adjustment bolt as well. In this version the positions of the ports in the guide and of those in the adjustment bolt can be independently selected to establish the degree of overlap during the no current state. Thus, the ports can be distributed in both components so that all are half covered by others while no current is flowing, allowing fluid to flow freely through only half the cross-section. In this case the dashpot will operate at an intermediate performance curve when the current fails.

To minimize the power consumption of the controls as much as possible, the port in the wall can be positioned to keep the bypass valve open as long as no current is flowing. In this state, the valve is mostly responsible for absorbing the shock, and the particular performance is dictated by the dashpot's other valves. Thus, the dashpot could for example include a “safe-driving valve”, with a comparatively soft performance curve, characterizing the mode that experience shows automobiles are usually driven in. When the bypass valve is open and no current is flowing, the channel leading to the safe-driving valve, and most of the dashpot's work will be taken over by the safe-driving valve. It can however, be considered a drawback in this situation when the dashpot remains constantly wide open in an emergency, very detrimental to safe driving, especially during a sudden lane change at a high speed because under these conditions the harder output curve would be needed to prevent the automobile's body from “kicking in” and to prevent breaking out. Driving can be made safer by ensuring that the bypass remains partly or entirely closed (partly open or closed while no current is flowing), so that the dashpot will perform harder.

When the device is operating “no current, open” and the force of absorption is to be increased to establish a more sports=car appropriate performance, the start-up current will be diverted to adjustment mechanism, shifting the adjustment bolt into a position partly closing off the port in the wall of the cylindrical guide. The impedance offered by the bypass valve will accordingly increase along with the shock-absorption force. Maximal shock-absorption force will have been attained when the adjustment mechanism's starting current is powerful enough for the adjustment bolt to arrive at a position wherein the port in the wall of the guide is completely closed off. The bypass valve is now completely closed.

From the state of the art of dashpots it is known that the shock-absorption activity of bypass valves like the one recited in the preamble to claim 1 can be regulated by changing the shape of the port or ports in the wall of the wall of the cylindrical guide. Different shapes, that is, result in different impedances. It will be evident that this relationship can also be exploited in the dashpot in accordance with the present invention. It will also be evident that the wall of the adjustment bolt need not absolutely be continuous, and the closing off of the ports can be determined strictly by the position of the free end of the adjustment bolt. Ports, rather, can even better be provided in the wall of the adjustment bolt that act in conjunction with the ports in the wall of the guide, the open cross-section available to the fluid now being determined by the extent to which the ports match each other. Obviously, the shapes that dictate the impedance can also be provided to the ports in the wall of the adjustment bolt instead of to those in the wall of the guide. This approach will facilitate finishing the specially shaped ports.

The bypass valve in accordance with the present invention can be employed with one-compartment or two-compartment dashpots. If the bypass valve is integrated into a separate module, one or even two modules can as known be mounted in the form of backpack valves on the outer surface of the tube. In order for example to allow mutually independent establishment of the compression and suction phases, two specially adapted modules accommodating bypass valves in accordance with the present invention can be mounted on the tube. In this event, one module will be active only during the decompression phase and the other only during the compression phase.

One of skill in the art will be aware that the shock-absorption behavior of an adjustable dashpot can be described by a performance-curve in the form of a diagram of shock absorption over speed (f/V). To attain uniform action on the part of the dashpot during the switch from one curve to an adjacent curve, an attempt should be made to maintain the curves as equidistant as possible (equidistant spread). The present invention now makes it possible by intentionally varying the shapes of the ports in the guide and in the adjustment bolt if desirable as well to establish a desired speed within the range of equidistant spread.

The present invention will now be specified with reference to the accompanying drawing, wherein

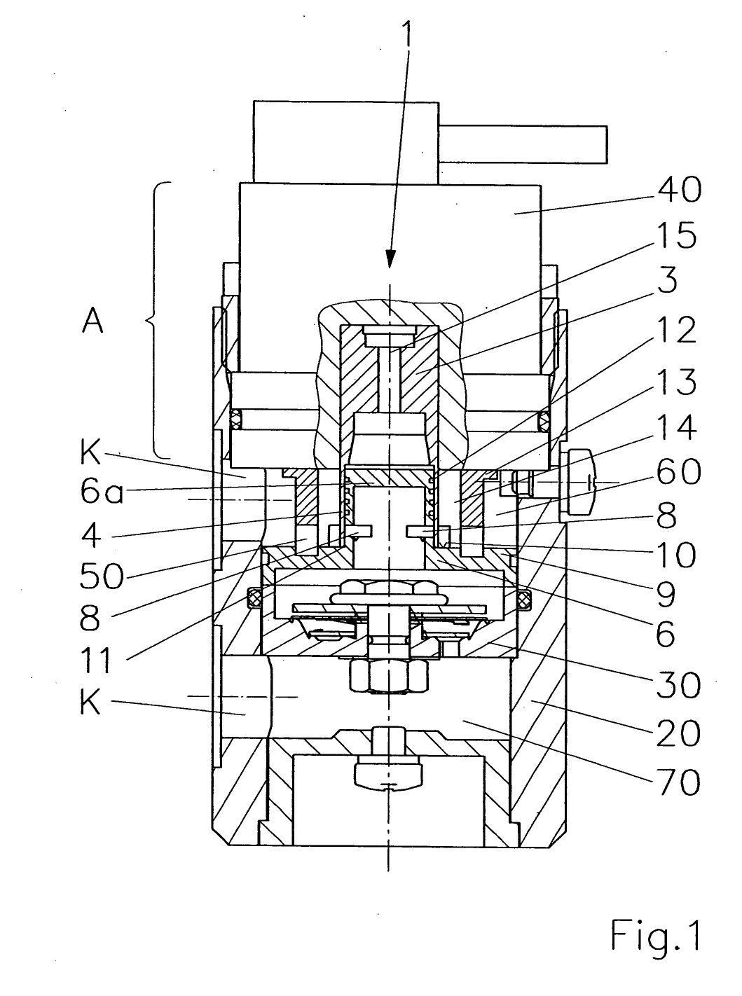

FIG. 1 is an axial longitudinal section through a modular bypass valve and

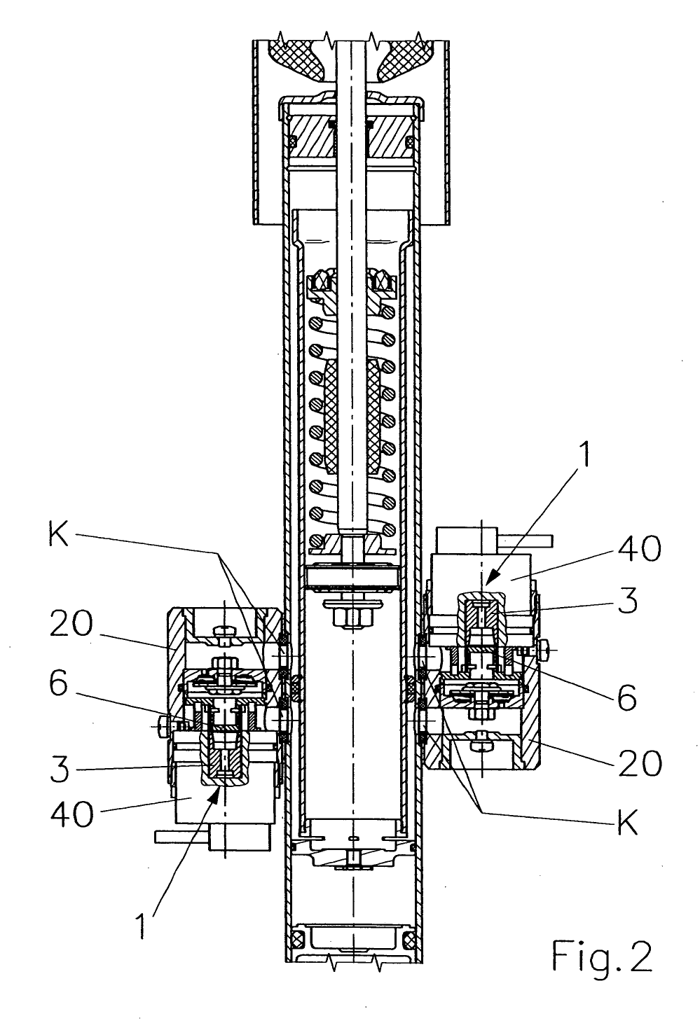

FIG. 2 an axial longitudinal section through two specially adapted external modules that accommodate the bypass valve.

The bypass valve illustrated in FIG. 1 is a backpack module. Its outer surface can be adapted in various known ways to fit an unillustrated overall housing in the form of a tube. The valve includes a modular housing 20, wherein a one-way safe-driving valve 30 is fixed radially and axially. Safe-driving valve 30 acts in the known way as a shock-absorption valve between the compression and suction phases of an unillustrated dashpot. Downstream of safe-driving valve 30 as viewed in FIG. 1 is a hollow cylindrical guide 6, also axially and radially fixed inside modular housing 20. The end of cylindrical guide 6 facing safe-driving valve 30 is provided with a shoulder 9. Shoulder 9 extends radially toward modular housing 20 and secures guide 6 axially and radially against modular housing 20. The hollow cylindrical section 6a of guide 6 extends from the end pointing axially away from safe-driving valve 30, creating a centering pin. A hollow cylindrical adjustment bolt 4 travels up and down along the pin. The adjustment bolt 4 depicted in FIG. 1 is in one piece with the shaft 3 of a valve bolt 1.

The shaft 3 in the illustrated embodiment constitutes a core accommodated within an electromagnet 40. Electromagnet 40 constitutes with shaft 3 a linear-drive mechanism that actuates adjustment bolt 4.

Hollow cylindrical adjustment bolt 4 is enclosed by an annular spacer 13, leaving an inner cylindrical gap 14. Inner cylindrical gap 14 communicates with an outer cylindrical gap 60 through bores in the wall of spacer 13. Outer cylindrical gap 60 can communicate with the working space of the unillustrated dashpot during either the compression or suction stage by way of a coupling bore K.

Accommodated in the wall of hollow-cylindrical adjustment bolt 4 are ports 8. The cross-section of ports 8 can be varied by axial displacement of adjustment bolt 4. As long as adjustment bolt 4 leaves ports 8 entirely open, outer cylindrical gap 60 will be hydraulically coupled to space 70 by way of safe-driving valve 30. In this situation, the performance of the backpack valve will be prescribed by safe-driving valve 30. The space 70 illustrated in FIG. 1 is communicating with the compression phase compartment of the unillustrated dashpot, and the outer cylindrical gap 60 with the suction-phase compartment. When the dashpot's piston rod is subjected to force and enters the dashpot, fluid will be forced out of the compression stage and into space 70, and hence into hollow-cylindrical guide 6, safe driving valve 30 inducing a particular shock-absorbing level. The fluid flows out of guide 6 and into inner cylindrical gap 14 through ports 8 and hence through bores 50 into outer cylindrical gap 60, which again communicates with the dashpot's suction stage. The free cross-section of ports 8 now assumes a choking function, which can be established by an intentional axial displacement of adjustment bolt 4, reducing the area of the ports. The backpack valve's shock-absorption performance can accordingly be continuously adjusted.

Adjustment bolt 4 is axially displaced along hollow-cylindrical guide 6 in accordance with the known state of the art by varying the current that activates electromagnet 40. The surface of shoulder 9 facing adjustment bolt 4 acts as a seat 10 that tightly accommodates the face of the adjustment bolt, preventing leakage. The face of the wall of adjustment bolt 4 toward seat 10 is provided with a sloping face 11, further reducing the area of the face of adjustment bolt 4, which accordingly offers less of a target to the fluctuations in pressure that occur in the flowing fluid. The resulting strain will be less powerfully transferred to adjustment bolt 4.

The advantage of the embodiment of the bypass valve in accordance with the present invention illustrated in FIG. 1 is that all the strains generated by the flowing fluid are almost entirely intercepted by the axially and radially fixed hollow cylindrical guide 6 and diverted into modular housing 20. Adjustment bolt 4 is accordingly uncoupled from the fluid induced strains. Since the friction between guide 6 and adjustment bolt 4 is also minimized, the axial displacement of the adjustment bolt 4 can be achieved by adjustment mechanism A with comparatively less force.

FIG. 2 illustrates a dashpot with two backpack valves, each comprising a valve in accordance with the present invention, adapted to the outer surface of its tube. The valve depicted on the right is similar to the one depicted in FIG. 1, and the dashpot is in action during the compression phase. The backpack valve on the left on the other hand is in action with the dashpot in the suction stage. The valve on the left is similar to the valve illustrated in FIG. 1 except that it has been rotated 180° in relation to the valve on the right. Thus, safe driving valve 30 acts with the fluid flowing in the opposite direction.

The dashpot illustrated in FIG. 2 makes it possible to establish performance curves independent of each other in the compression and suction phases. This feature provides the conditions for “skyhook” shock absorption. It is also possible to rotate the safe-driving valve 180° instead of the entire module.

### List of Parts

1. valve bolt
3. shaft
4. adjustment bolt
6. guide
6a. hollow cylindrical section
8. port
9. shoulder
10. seat
11. sloping face
12. bleed groove
13. spacer
14. inner cylindrical gap
15. vent
20. modular housing
30. easy-driving valve
40. electromagnet
50. bore
60. outer cylindrical gap
70. space
A. adjustment mechanism
B. coupling bore

1. Bypass valve for a hydraulic dashpot, or shock absorber, that connects the dashpot's two working compartments together hydraulically and that is provided with a valve bolt (1), whereby the valve bolt has a shaft (3) and a hollow adjustment bolt, and whereby the adjustment bolt slides back and forth in a stationary and at least partly hollow guide and operates in conjunction with at least one port (8) in the wall of the guide such that the open cross-section of the port can be varied by the axial motion of the adjustment bolt, and with a mechanism (A) for controlling the axial motion of the adjustment bolt, characterized in that the guide is fixed axially and radially and in that the adjustment bolt is larger than the guide, which accordingly constitutes a pin that the adjustment bolt can slide over axially.

2. Bypass valve as in claim 1, characterized in that the adjustment bolt (4) and the guide (6) are hollow cylinders.

3. Bypass valve as in claim 1, wherein the shaft (3) and the adjustment bolt (4) constitute a single integrated component.

4. Bypass valve as in claim 1, wherein that the adjustment mechanism (A) is an electromagnetic linear drive mechanism comprising a coil and a core, whereby the adjustment bolt (4) acts as the core and travels back and forth inside the coil into a prescribed position depending on the strength of the electric current.

5. Bypass valve as in claim 1, wherein that the end of the guide (6) proximate to the shaft (3) of the valve bolt (1) is provided with a shoulder (9) perpendicular to the guide's longitudinal axis, whereby the face of the shoulder facing the adjustment bolt (4) constitutes a seat (10), on which the free end of the bolt can rest tight.

6. Bypass valve as in claim 1, wherein that the end of the, hollow, adjustment bolt (4) facing away from the shaft (3) is provided with a sloping face (11).

7. Bypass valve as in claim 1, wherein in that the wall of the guide (6) is provided with at least one bleed groove (12) that operates in conjunction with the inner surface of the adjustment bolt (4).

8. Bypass valve as in claim 7, characterized by at least one bleed groove (12) above the port (8).

9. Bypass valve as in claim 1, including a spacer (13) coaxial with the adjustment bolt (4) and the guide (6), loosely enclosing the adjustment bolt, and accordingly leaving an inner cylindrical gap (14) between the bolt and the spacer.

10. Bypass valve as in claim 1, wherein in that the shaft (3) of the valve bolt (1) is provided with a vent(15).

11. Bypass valve as in claim 1, wherein in that the shape of the at least one port (8) allows the range of speeds that includes an equidistant performance-curve spread to be selected.
